(19) United States
(12) Patent Application Publication
(10) Pub. No.: US 2026/0246931 A1
(43) Pub. Date: Aug. 20, 2026

(54) DATA ENCODING AND DECODING

(71) Applicant: Sony Group Corporation, Tokyo (JP)

(72) Inventors: Stephen Mark KEATING, Reading (GB); Karl James SHARMAN, Basingstoke (GB); Adrian Richard BROWNE, Southampton (GB)

(21) Appl. No.: 19/165,541

(22) PCT Filed: Mar. 18, 2024
(86) PCT No.: PCT/EP2024/057194

§ 371 Date: Sep. 15, 2025

(30) Foreign Application Priority Data
Mar. 30, 2023 (GB) 2304752.5

(51) Int. Cl. H04N 19/119; H04N 19/176; H04N 19/196; H04N 19/436

(52) U.S. Cl. CPC H04N 19/119; H04N 19/176; H04N 19/196; H04N 19/436

(57) ABSTRACT

A data encoding method is provided, the data encoding method comprising: acquiring a block of image data to be encoded, the block being formed of a number of data items; splitting the block of image data into a number of sets, each set having a predetermined length in data items; for each set, in parallel: encoding each data item of the set using a context model, the context model having a predetermined configuration; and incrementing a counter in dependence upon a value being encoded, wherein the counter is shared across the number of sets; and, when the sets have been encoded, updating the predetermined configuration of the context model in dependence upon the value of the counter. A data decoding method is also provided.

### BACKGROUND

### Field

This disclosure relates to data encoding and decoding.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, is neither expressly or impliedly admitted as prior art against the present disclosure.

There are several systems, such as video or image data encoding and decoding systems, which involve transforming video data into a frequency domain representation, quantising the frequency domain coefficients and then applying some form of entropy encoding to the quantised coefficients. This can achieve compression of the video data. A corresponding decoding or decompression technique is applied to recover a reconstructed version of the original video data.

Encoding systems such as these may perform a number of trial encodings of image data, with each trial encoding of the image data using a number of different encoding options (such as block size and shape, for example). The encoding system may then make a choice concerning a final encoding of the image data according to the cost of each potential selection in terms of one or both of the number of bits required for encoding and distortion to the picture.

While the use of trial encodings of the image data may result in a more efficient bit-stream, the computational effort required to perform the trial encodings of the image data can be high. This may impact the speed of the encoding process. Accordingly, it can be difficult to provide an encoding system that can produce an efficient bit-stream, capable of being decoded by a corresponding decoding system, in a short period of time.

Furthermore, certain limitations on computational resources and/or time may cause the encoding system to reduce the number of trial encodings of the image data. However, a reduction in the number of trial encodings may reduce the coding efficiency of the system.

It is an aim of the present disclosure to address these issues.

### SUMMARY

Aspects of the present disclosure are defined by the appended claims.

Further respective aspects and features of the present disclosure are defined in the appended claims.

It is to be understood that both the foregoing general description and the following detailed description are exemplary, but are not restrictive, of the present technology.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 schematically illustrates an audio/video (A/V) data transmission and reception system using video data compression and decompression;

FIG. 2 schematically illustrates a video display system using video data decompression;

FIG. 3 schematically illustrates an audio/video storage system using video data compression and decompression;

FIG. 4 schematically illustrates a video camera using video data compression;

FIGS. 5 and 6 schematically illustrate storage media;

FIG. 7 provides a schematic overview of a video data compression and decompression apparatus;

FIG. 8 schematically illustrates a predictor;

FIG. 9 schematically illustrates a transform-skip mode;

FIGS. 10a, 10b, 11a and 11b schematically illustrate respective scanning directions;

FIG. 12 schematically illustrates a block of image data in accordance with embodiments of the disclosure;

FIG. 13 schematically illustrates a block of image data in accordance with embodiments of the disclosure;

FIG. 14 illustrates an encoding method in accordance with embodiments of the disclosure;

FIG. 15A illustrates an encoding method in accordance with embodiments of the disclosure;

FIG. 15B illustrates an encoding method in accordance with embodiments of the disclosure;

FIG. 16 illustrates a block of image data in accordance with embodiments of the disclosure;

FIG. 17 illustrates an example processing flow in accordance with embodiments of the disclosure;

FIG. 18 illustrates an encoding method in accordance with embodiments of the disclosure; and

FIGS. 19A and 19B illustrate an example data encoding method in accordance with embodiments of the disclosure.

### DESCRIPTION OF THE PREFERRED EMBODIMENTS

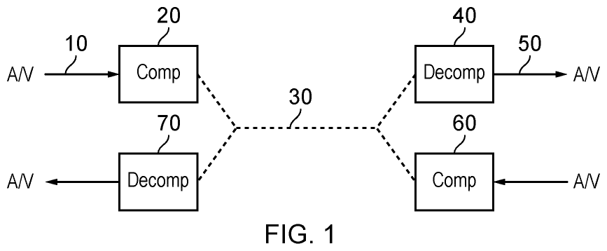

Referring now to the drawings, FIGS. 1-4 are provided to give schematic illustrations of apparatus or systems making use of the compression and/or decompression apparatus to be described below in connection with embodiments of the present technology.

All of the data compression and/or decompression apparatus to be described below may be implemented in hardware, in software running on a general-purpose data processing apparatus such as a general-purpose computer, as programmable hardware such as an application specific integrated circuit (ASIC) or field programmable gate array (FPGA) or as combinations of these. In cases where the embodiments are implemented by software and/or firmware, it will be appreciated that such software and/or firmware, and non-transitory data storage media by which such software and/or firmware are stored or otherwise provided, are considered as embodiments of the present technology.

FIG. 1 schematically illustrates an audio/video data transmission and reception system using video data compression and decompression. In this example, the data values to be encoded or decoded represent image data.

An input audio/video signal 10 is supplied to a video data compression apparatus 20 which compresses at least the video component of the audio/video signal 10 for transmission along a transmission route 30 such as a cable, an optical fibre, a wireless link or the like. The compressed signal is processed by a decompression apparatus 40 to provide an output audio/video signal 50. For the return path, a compression apparatus 60 compresses an audio/video signal for transmission along the transmission route 30 to a decompression apparatus 70.

The compression apparatus 20 and decompression apparatus 70 can therefore form one node of a transmission link. The decompression apparatus 40 and decompression apparatus 60 can form another node of the transmission link. Of course, in instances where the transmission link is uni-directional, only one of the nodes would require a compression apparatus and the other node would only require a decompression apparatus.

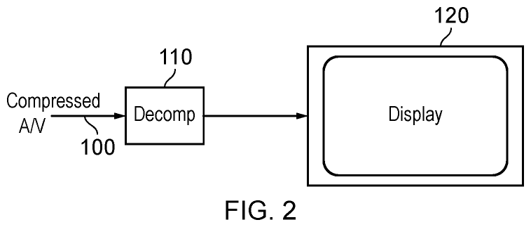

FIG. 2 schematically illustrates a video display system using video data decompression. In particular, a compressed audio/video signal 100 is processed by a decompression apparatus 110 to provide a decompressed signal which can be displayed on a display 120. The decompression apparatus 110 could be implemented as an integral part of the display 120, for example being provided within the same casing as the display device. Alternatively, the decompression apparatus 110 maybe provided as (for example) a so-called set top box (STB), noting that the expression “set-top” does not imply a requirement for the box to be sited in any particular orientation or position with respect to the display 120; it is simply a term used in the art to indicate a device which is connectable to a display as a peripheral device.

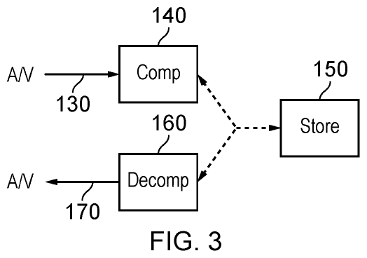

FIG. 3 schematically illustrates an audio/video storage system using video data compression and decompression. An input audio/video signal 130 is supplied to a compression apparatus 140 which generates a compressed signal for storing by a store device 150 such as a magnetic disk device, an optical disk device, a magnetic tape device, a solid state storage device such as a semiconductor memory or other storage device. For replay, compressed data is read from the storage device 150 and passed to a decompression apparatus 160 for decompression to provide an output audio/video signal 170.

It will be appreciated that the compressed or encoded signal, and a storage medium such as a machine-readable non-transitory storage medium, storing that signal, are considered as embodiments of the present technology.

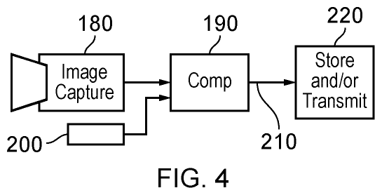

FIG. 4 schematically illustrates a video camera using video data compression. In FIG. 4, an image capture device 180, such as a charge coupled device (CCD) image sensor and associated control and read-out electronics, generates a video signal which is passed to a compression apparatus 190. A microphone (or plural microphones) 200 generates an audio signal to be passed to the compression apparatus 190. The compression apparatus 190 generates a compressed audio/video signal 210 to be stored and/or transmitted (shown generically as a schematic stage 220).

The techniques to be described below relate primarily to video data compression and decompression. It will be appreciated that many existing techniques may be used for audio data compression in conjunction with the video data compression techniques which will be described, to generate a compressed audio/video signal. Accordingly, a separate discussion of audio data compression will not be provided. It will also be appreciated that the data rate associated with video data, in particular broadcast quality video data, is generally very much higher than the data rate associated with audio data (whether compressed or uncompressed). It will therefore be appreciated that uncompressed audio data could accompany compressed video data to form a compressed audio/video signal. It will further be appreciated that although the present examples (shown in FIGS. 1-4) relate to audio/video data, the techniques to be described below can find use in a system which simply deals with (that is to say, compresses, decompresses, stores, displays and/or transmits) video data. That is to say, the embodiments can apply to video data compression without necessarily having any associated audio data handling at all.

FIG. 4 therefore provides an example of a video capture apparatus comprising an image sensor and an encoding apparatus of the type to be discussed below. FIG. 2 therefore provides an example of a decoding apparatus of the type to be discussed below and a display to which the decoded images are output.

A combination of FIGS. 2 and 4 may provide a video capture apparatus comprising an image sensor 180 and encoding apparatus 190, decoding apparatus 110 and a display 120 to which the decoded images are output.

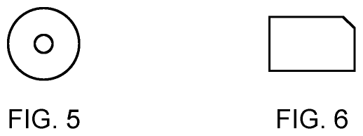

FIGS. 5 and 6 schematically illustrate storage media, which store (for example) the compressed data generated by the apparatus 20, 60, the compressed data input to the apparatus 110 or the storage media or stages 150, 220. FIG. 5 schematically illustrates a disc storage medium such as a magnetic or optical disc, and FIG. 6 schematically illustrates a solid state storage medium such as a flash memory. Note that FIGS. 5 and 6 can also provide examples of non-transitory machine-readable storage media which store computer software which, when executed by a computer, causes the computer to carry out one or more of the methods to be discussed below.

Therefore, the above arrangements provide examples of video storage, capture, transmission or reception apparatuses embodying any of the present techniques.

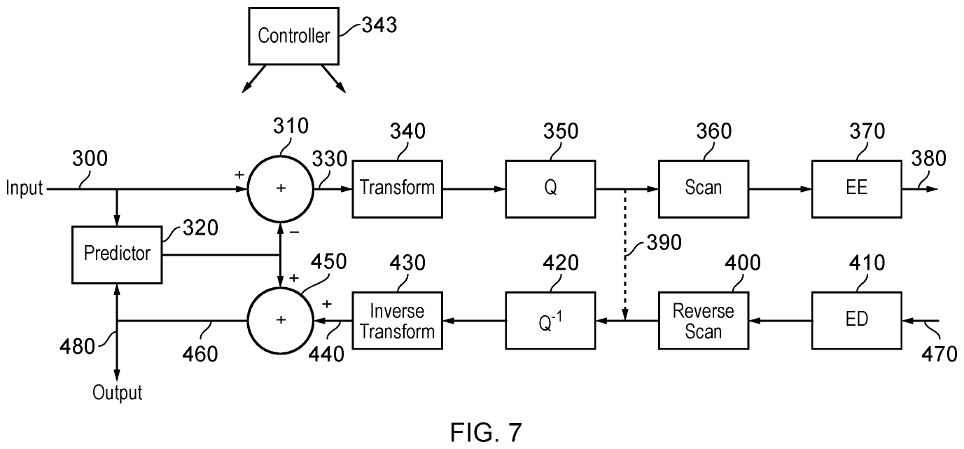

FIG. 7 provides a schematic overview of a video or image data compression and decompression apparatus, for encoding and/or decoding image data representing one or more images.

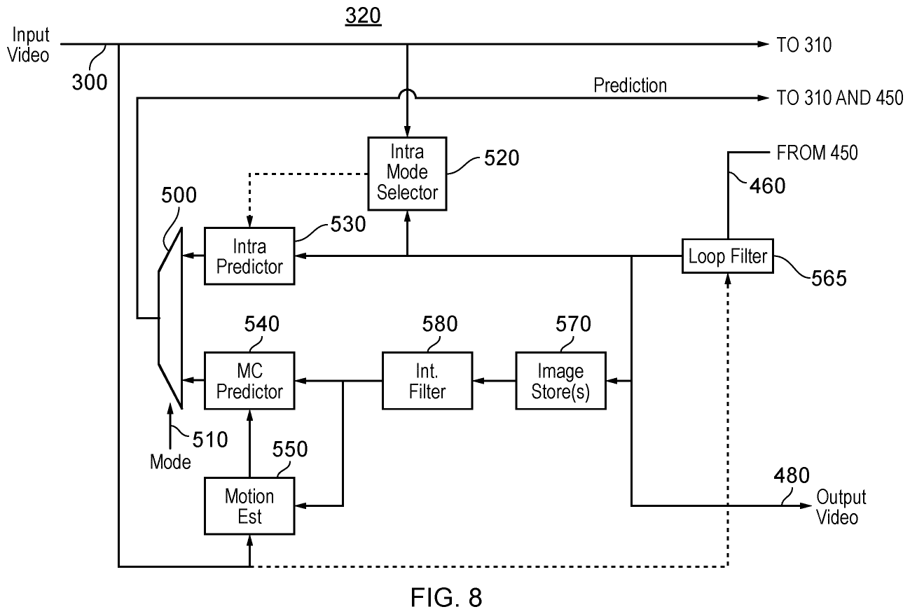

A controller 343 controls the overall operation of the apparatus and, in particular when referring to a compression mode, controls a trial encoding processes by acting as a selector to select various modes of operation such as block sizes and shapes, and whether the video data is to be encoded losslessly or otherwise. The controller is considered to form part of the image encoder or image decoder (as the case may be). Successive images of an input video signal 300 are supplied to an adder 310 and to an image predictor 320. The image predictor 320 will be described below in more detail with reference to FIG. 8. The image encoder or decoder (as the case may be) plus the intra-image predictor of FIG. 8 may use features from the apparatus of FIG. 7. This does not mean that the image encoder or decoder necessarily requires every feature of FIG. 7 however.

The adder 310 in fact performs a subtraction (negative addition) operation, in that it receives the input video signal 300 on a “+” input and the output of the image predictor 320 on a “−” input, so that the predicted image is subtracted from the input image. The result is to generate a so-called residual image signal 330 representing the difference between the actual and predicted images.

One reason why a residual image signal is generated is as follows. The data coding techniques to be described, that is to say the techniques which will be applied to the residual image signal, tend to work more efficiently when there is less “energy” in the image to be encoded. Here, the term “efficiently” refers to the generation of a small amount of encoded data; for a particular image quality level, it is desirable (and considered “efficient”) to generate as little data as is practicably possible. The reference to “energy” in the residual image relates to the amount of information contained in the residual image. If the predicted image were to be identical to the real image, the difference between the two (that is to say, the residual image) would contain zero information (zero energy) and would be very easy to encode into a small amount of encoded data. In general, if the prediction process can be made to work reasonably well such that the predicted image content is similar to the image content to be encoded, the expectation is that the residual image data will contain less information (less energy) than the input image and so will be easier to encode into a small amount of encoded data.

Therefore, encoding (using the adder 310) involves predicting an image region for an image to be encoded; and generating a residual image region dependent upon the difference between the predicted image region and a corresponding region of the image to be encoded. In connection with the techniques to be discussed below, the ordered array of data values comprises data values of a representation of the residual image region. Decoding involves predicting an image region for an image to be decoded; generating a residual image region indicative of differences between the predicted image region and a corresponding region of the image to be decoded; in which the ordered array of data values comprises data values of a representation of the residual image region; and combining the predicted image region and the residual image region.

The remainder of the apparatus acting as an encoder (to encode the residual or difference image) will now be described.

The residual image data 330 is supplied to a transform unit or circuitry 340 which generates a discrete cosine transform (DCT) representation of blocks or regions of the residual image data. The DCT technique itself is well known and will not be described in detail here. Note also that the use of DCT is only illustrative of one example arrangement. Other transforms which might be used include, for example, the discrete sine transform (DST). A transform could also comprise a sequence or cascade of individual transforms, such as an arrangement in which one transform is followed (whether directly or not) by another transform. The choice of transform may be determined explicitly and/or be dependent upon side information used to configure the encoder and decoder. In other examples a so-called “transform-skip” mode can selectively be used in which no transform is applied.

Therefore, in examples, an encoding and/or decoding method comprises predicting an image region for an image to be encoded; and generating a residual image region dependent upon the difference between the predicted image region and a corresponding region of the image to be encoded; in which the ordered array of data values (to be discussed below) comprises data values of a representation of the residual image region.

The output of the transform unit 340, which is to say (in an example), a set of DCT coefficients for each transformed block of image data, is supplied to a quantiser 350. Various quantisation techniques are known in the field of video data compression, ranging from a simple multiplication by a quantisation scaling factor through to the application of complicated lookup tables under the control of a quantisation parameter. The general aim is twofold. Firstly, the quantisation process reduces the number of possible values of the transformed data. Secondly, the quantisation process can increase the likelihood that values of the transformed data are zero. Both of these can make the entropy encoding process, to be described below, work more efficiently in generating small amounts of compressed video data.

A data scanning process is applied by a scan unit 360. The purpose of the scanning process is to reorder the quantised transformed data so as to gather as many as possible of the non-zero quantised transformed coefficients together, and of course therefore to gather as many as possible of the zero-valued coefficients together. These features can allow so-called run-length coding or similar techniques to be applied efficiently. So, the scanning process involves selecting coefficients from the quantised transformed data, and in particular from a block of coefficients corresponding to a block of image data which has been transformed and quantised, according to a “scanning order” so that (a) all of the coefficients are selected once as part of the scan, and (b) the scan tends to provide the desired reordering. One example scanning order which can tend to give useful results is a diagonal order such as a so-called up-right diagonal scanning order.

The scanning order can be different, as between transform-skip blocks and transform blocks (blocks which have undergone at least one spatial frequency transformation).

The scanned coefficients are then passed to an entropy encoder (EE) 370. Again, various types of entropy encoding may be used. Two examples are variants of the so-called CABAC (Context Adaptive Binary Arithmetic Coding) system and variants of the so-called CAVLC (Context Adaptive Variable-Length Coding) system. In general terms, CABAC is considered to provide a better efficiency, and in some studies has been shown to provide a 10-20% reduction in the quantity of encoded output data for a comparable image quality compared to CAVLC. However, CAVLC is considered to represent a much lower level of complexity (in terms of its implementation) than CABAC. Note that the scanning process and the entropy encoding process are shown as separate processes, but in fact can be combined or treated together. That is to say, the reading of data into the entropy encoder can take place in the scan order. Corresponding considerations apply to the respective inverse processes to be described below.

The output of the entropy encoder 370, along with additional data (mentioned above and/or discussed below), for example defining the manner in which the predictor 320 generated the predicted image, whether the compressed data was transformed or transform-skipped or the like, provides a compressed output video signal 380.

However, a return path 390 is also provided because the operation of the predictor 320 itself depends upon a decompressed version of the compressed output data.

The reason for this feature is as follows. At the appropriate stage in the decompression process (to be described below) a decompressed version of the residual data is generated. This decompressed residual data has to be added to a predicted image to generate an output image (because the original residual data was the difference between the input image and a predicted image). In order that this process is comparable, as between the compression side and the decompression side, the predicted images generated by the predictor 320 should be the same during the compression process and during the decompression process. Of course, at decompression, the apparatus does not have access to the original input images, but only to the decompressed images. Therefore, at compression, the predictor 320 bases its prediction (at least, for inter-image encoding) on decompressed versions of the compressed images.

The entropy encoding process carried out by the entropy encoder 370 is considered (in at least some examples) to be “lossless”, which is to say that it can be reversed to arrive at exactly the same data which was first supplied to the entropy encoder 370. So, in such examples the return path can be implemented before the entropy encoding stage. Indeed, the scanning process carried out by the scan unit 360 is also considered lossless, so in the present embodiment the return path 390 is from the output of the quantiser 350 to the input of a complimentary inverse quantiser 420. In instances where loss or potential loss is introduced by a stage, that stage (and its inverse) may be included in the feedback loop formed by the return path. For example, the entropy encoding stage can at least in principle be made lossy, for example by techniques in which bits are encoded within parity information. In such an instance, the entropy encoding and decoding should form part of the feedback loop.

In general terms, an entropy decoder 410, the reverse scan unit 400, an inverse quantiser 420 and an inverse transform unit or circuitry 430 provide the respective inverse functions of the entropy encoder 370, the scan unit 360, the quantiser 350 and the transform unit 340. For now, the discussion will continue through the compression process; the process to decompress an input compressed video signal will be discussed separately below.

In the compression process, the scanned coefficients are passed by the return path 390 from the quantiser 350 to the inverse quantiser 420 which carries out the inverse operation of the scan unit 360. An inverse quantisation and inverse transformation process are carried out by the units 420, 430 to generate a compressed-decompressed residual image signal 440.

The image signal 440 is added, at an adder 450, to the output of the predictor 320 to generate a reconstructed output image 460 (although this may be subject to so-called loop filtering and/or other filtering before being output-see below). This forms one input to the image predictor 320, as will be described below.

Turning now to the decoding process applied to decompress a received compressed video signal 470, the signal is supplied to the entropy decoder 410 and from there to the chain of the reverse scan unit 400, the inverse quantiser 420 and the inverse transform unit 430 before being added to the output of the image predictor 320 by the adder 450. So, at the decoder side, the decoder reconstructs a version of the residual image and then applies this (by the adder 450) to the predicted version of the image (on a block by block basis) so as to decode each block. In straightforward terms, the output 460 of the adder 450 forms the output decompressed video signal 480 (subject to the filtering processes discussed below). In practice, further filtering may optionally be applied (for example, by a loop filter 565 shown in FIG. 8 but omitted from FIG. 7 for clarity of the higher level diagram of FIG. 7) before the signal is output.

The apparatus of FIGS. 7 and 8 can act as a compression (encoding) apparatus or a decompression (decoding) apparatus. The functions of the two types of apparatus substantially overlap. The scan unit 360 and entropy encoder 370 are not used in a decompression mode, and the operation of the predictor 320 (which will be described in detail below) and other units follow mode and parameter information contained in the received compressed bit-stream rather than generating such information themselves.

FIG. 8 schematically illustrates the generation of predicted images, and in particular the operation of the image predictor 320.

There are two basic modes of prediction carried out by the image predictor 320: so-called intra-image prediction and so-called inter-image, or motion-compensated (MC), prediction. At the encoder side, each involves detecting a prediction direction in respect of a current block to be predicted, and generating a predicted block of samples according to other samples (in the same (intra) or another (inter) image). By virtue of the units 310 or 450, the difference between the predicted block and the actual block is encoded or applied so as to encode or decode the block respectively.

(At the decoder, or at the reverse decoding side of the encoder, the detection of a prediction direction may be in response to data associated with the encoded data by the encoder, indicating which direction was used at the encoder. Or the detection may be in response to the same factors as those on which the decision was made at the encoder).

Intra-image prediction bases a prediction of the content of a block or region of the image on data from within the same image. This corresponds to so-called I-frame encoding in other video compression techniques. In contrast to I-frame encoding, however, which involves encoding the whole image by intra-encoding, in the present embodiments the choice between intra- and inter-encoding can be made on a block-by-block basis, though in other embodiments the choice is still made on an image-by-image basis.

Motion-compensated prediction is an example of inter-image prediction and makes use of motion information which attempts to define the source, in another adjacent or nearby image, of image detail to be encoded in the current image. Accordingly, in an ideal example, the contents of a block of image data in the predicted image can be encoded very simply as a reference (a motion vector) pointing to a corresponding block at the same or a slightly different position in an adjacent image.

A technique known as “block copy” prediction is in some respects a hybrid of the two, as it uses a vector to indicate a block of samples at a position displaced from the currently predicted block within the same image, which should be copied to form the currently predicted block.

Returning to FIG. 8, two image prediction arrangements (corresponding to intra- and inter-image prediction) are shown, the results of which are selected by a multiplexer 500 under the control of a mode signal 510 (for example, from the controller 343) so as to provide blocks of the predicted image for supply to the adders 310 and 450. The choice is made in dependence upon which selection gives the lowest “energy” (which, as discussed above, may be considered as information content requiring encoding), and the choice is signalled to the decoder within the encoded output data-stream. Image energy, in this context, can be detected, for example, by carrying out a trial subtraction of an area of the two versions of the predicted image from the input image, squaring each pixel value of the difference image, summing the squared values, and identifying which of the two versions gives rise to the lower mean squared value of the difference image relating to that image area. In other examples, a trial encoding can be carried out for each selection or potential selection, with a choice then being made according to the cost of each potential selection in terms of one or both of the number of bits required for encoding and distortion to the picture.

The actual prediction, in the intra-encoding system, is made on the basis of image blocks received as part of the signal 460 (as filtered by loop filtering; see below), which is to say, the prediction is based upon encoded-decoded image blocks in order that exactly the same prediction can be made at a decompression apparatus. However, data can be derived from the input video signal 300 by an intra-mode selector 520 to control the operation of the intra-image predictor 530.

For inter-image prediction, a motion compensated (MC) predictor 540 uses motion information such as motion vectors derived by a motion estimator 550 from the input video signal 300. Those motion vectors are applied to a processed version of the reconstructed image 460 by the motion compensated predictor 540 to generate blocks of the inter-image prediction.

Accordingly, the units 530 and 540 (operating with the estimator 550) each act as detectors to detect a prediction direction in respect of a current block to be predicted, and as a generator to generate a predicted block of samples (forming part of the prediction passed to the units 310 and 450) according to other samples defined by the prediction direction.

The processing applied to the signal 460 will now be described.

Firstly, the signal may be filtered by a so-called loop filter 565. Various types of loop filters may be used. One technique involves applying a “deblocking” filter to remove or at least tend to reduce the effects of the block-based processing carried out by the transform unit 340 and subsequent operations. A further technique involving applying a so-called sample adaptive offset (SAO) filter may also be used. In general terms, in a sample adaptive offset filter, filter parameter data (derived at the encoder and communicated to the decoder) defines one or more offset amounts to be selectively combined with a given intermediate video sample (a sample of the signal 460) by the sample adaptive offset filter in dependence upon a value of: (i) the given intermediate video sample; or (ii) one or more intermediate video samples having a predetermined spatial relationship to the given intermediate video sample.

Also, an adaptive loop filter is optionally applied using coefficients derived by processing the reconstructed signal 460 and the input video signal 300. The adaptive loop filter is a type of filter which, using known techniques, applies adaptive filter coefficients to the data to be filtered. That is to say, the filter coefficients can vary in dependence upon various factors. Data defining which filter coefficients to use is included as part of the encoded output data-stream.

The filtered output from the loop filter unit 565 in fact forms the output video signal 480 when the apparatus is operating as a decompression apparatus. It is also buffered in one or more image or frame stores 570; the storage of successive images is a requirement of motion compensated prediction processing, and in particular the generation of motion vectors. To save on storage requirements, the stored images in the image stores 570 may be held in a compressed form and then decompressed for use in generating motion vectors. For this particular purpose, any known compression/decompression system may be used. The stored images may be passed to an interpolation filter 580 which generates a higher resolution version of the stored images; in this example, intermediate samples (sub-samples) are generated such that the resolution of the interpolated image is output by the interpolation filter 580 is 4 times (in each dimension) that of the images stored in the image stores 570 for the luminance channel of 4:2:0 and 8 times (in each dimension) that of the images stored in the image stores 570 for the chrominance channels of 4:2:0. The interpolated images are passed as an input to the motion estimator 550 and also to the motion compensated predictor 540.

The way in which an image is partitioned for compression processing will now be described. At a basic level, an image to be compressed is considered as an array of blocks or regions of samples. The splitting of an image into such blocks or regions can be carried out by a decision tree, such as that described in SERIES H: AUDIOVISUAL AND MULTIMEDIA SYSTEMS Infrastructure of audio-visual services-Coding of moving video High efficiency video coding Recommendation ITU-T H.265 12/2016. Also: High Efficiency Video Coding (HEVC) algorithms and Architectures, Editors: Madhukar Budagavi, Gary J. Sullivan, Vivienne Sze; chapter 3; ISBN 978-3-319-06894-7; 2014 which are incorporated herein in their respective entireties by reference.

In some examples, the resulting blocks or regions have sizes and, in some cases, shapes which, by virtue of the decision tree, can generally follow the disposition of image features within the image. This in itself can allow for an improved encoding efficiency because samples representing or following similar image features would tend to be grouped together by such an arrangement. In some examples, square blocks or regions of different sizes (such as 4×4 samples up to, say, 64×64 or larger blocks) are available for selection. In other example arrangements, blocks or regions of different shapes such as rectangular blocks or arrays (for example, vertically or horizontally oriented) can be used. Other non-square and non-rectangular blocks are envisaged. The result of the division of the image into such blocks or regions is (in at least the present examples) that each sample of an image is allocated to one, and only one, such block or region.

### Transform-Skip Mode

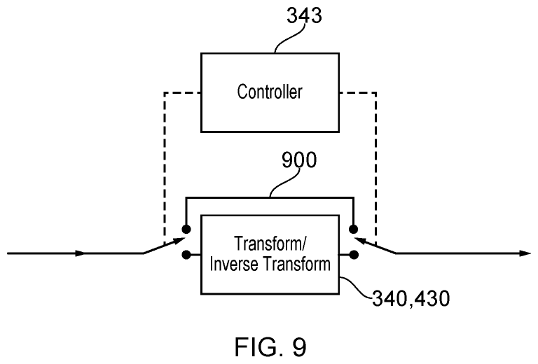

FIG. 9 schematically illustrates a so-called transform-skip mode. In this mode, blocks of samples, for example rectangular encoding blocks or arrays of samples such as so-called transform units (TUs) are assigned a ‘transform-skip’ mode indicator, for example by a part of the functionality of the controller 343. When the transform-skip indicator is set, as shown by the schematic bypass path 900 in FIG. 9, the transform unit 340 (in the encoding path) and the inverse transform unit 430 (in the decoding path of the encoding side or in a decoder) is bypassed so that no spatial frequency transform is applied to the samples in that particular block.

The transform-skip mode is selectable by the controller 343, alongside a possible selection, of, DCT, DST or another transform mode, in dependence upon properties of the block in question, properties of nearby blocks, trial (full or partial) encodings or the like. Generally, the aim of the selection algorithm executed by the controller 343 is to improve the efficiency of the encoding of the block in question.

In some previously proposed example arrangements, transform-skip mode was restricted to 4×4 block sizes or smaller. In more recent examples, this restriction has been relaxed and the transform-skip mode can be selectively applied to larger blocks. The transform-skip mode can be applied to a TU even when the TU is actually processed as multiple (smaller) sub-TUs.

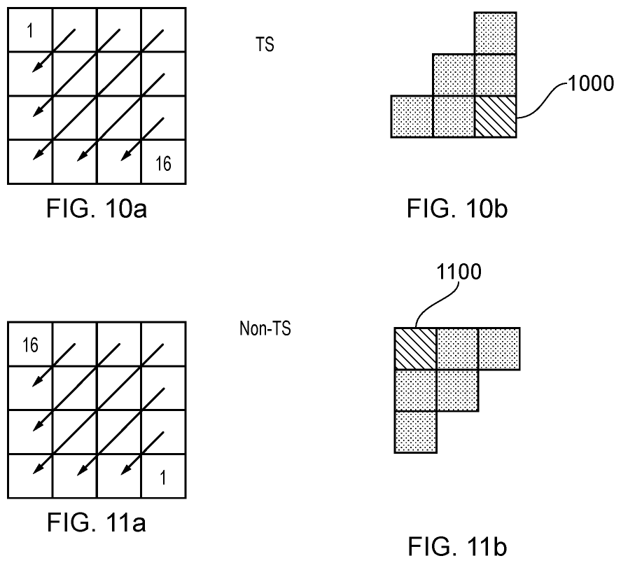

FIGS. 10a and 11a schematically illustrate respective scanning directions, with FIG. 10a providing an example applicable to a 4×4 transform-skip block and FIG. 11a providing an example applicable to a so-called transform block, which is to say a block for which transform-skip mode was not enabled and so the block has undergone a spatial frequency transform (or more than one frequency transform) by the transform unit 340 during encoding.

Referring to FIG. 10a, in the case of transform-skip blocks, the scan order is in this example a diagonal order from the top left (“1”) to lower right (“16”). In contrast, as shown in FIG. 11a, in the case of a transform block (as an example of an encoding block) the scan order is a diagonal order from the lower right to top left. Note that the scan order in use makes little substantive difference to the techniques to be discussed below other than in terms of which coefficients or samples are available “already encoded” or “already decoded” for use in the derivation of encoding parameters for subsequent samples or coefficients.

In the case of larger blocks, a similar scan order can be used, or sub-blocks of (for example) 4×4 coefficients such as sub-TUs can be scanned as shown, with a predetermined pattern being used to scan each sub-block in order.

In general terms, the blocks of samples or coefficients may be considered as groups of data values (or, once encoded, groups of encoded data values), each having an associated encoding order (in other words, the scan order as illustrated by the examples of FIGS. 10a and 11a).

Referring to FIGS. 10b and 11b, in at least some examples of processing to be discussed below, reference is made to samples or coefficients (which may for convenience be referred to below by the single generic term “coefficients” even in the case of transform-skip blocks) which have been encoded or decoded before encoding or decoding of a given coefficient 1000, 1100. In the case of transform-skip, the previously handled coefficients relevant to at least some of the techniques discussed below will be coefficients in a predetermined grouping or pattern as shown in shaded form (one box for each coefficient), which are above and left of the given coefficient 1000. In the case of non-transform-skip operation, a similar predetermined pattern or grouping is used but here the previously handled coefficients relevant to at least some of the techniques discussed below are coefficients (shown shaded) below and to the right of the given coefficient 1100. As mentioned, these coefficients will be referred to by at least some techniques below. If any coefficient in the relevant shaded group is unavailable, for example because it would fall into another block or a not-yet encoded or not-yet-decoded block, that coefficient is simply omitted from the respective process and where necessary, the result of the process may be normalised to the reduced number of coefficients. (For example, normalisation is relevant to a process deriving a mean of the shaded coefficients but is not relevant to a process detecting a maximum or minimum of the shaded coefficients).

### Trial Encoding

As previously explained, encoding systems may perform a number of trial encodings of image data, with each trial encoding of the image data using a number of different encoding options (such as block size and shape, for example). The encoding system may then make a choice concerning a final encoding of the image data according to the cost of each potential selection in terms of one or both of the number of bits required for encoding and distortion to the picture.

Consider, again, the example of FIG. 7 of the present disclosure. The example of FIG. 7 of the present disclosure provides a schematic overview of a video or image data compression and decompression apparatus, for encoding and/or decoding image data representing one or more images. In the example of FIG. 7, the controller 343 controls the overall operation of the apparatus and, in particular when referring to the compression mode, controls the trial encoding process. Accordingly, in the example of FIG. 7 of the present disclosure, the controller controls the trial encoding process by acting as a selector to select various modes of operation such as block sizes and shapes.

The use of a trial encoding process is advantageous, as it enables the compression apparatus to test a number of different ways of encoding the image data. The different ways of encoding the image data (such as different block sizes and shapes) can then be compared in order to identify which of the different ways of encoding the image data should be used during the final encoding of the image data according to the cost of each potential selection in terms of one or both of the number of bits required for encoding and distortion to the picture. Once the selection has been made, the controller 343 can then control the encoding apparatus to perform the final encoding of the image data to produce the encoded bit-stream.

In other words, trial encoding (often performed by an encoder during as part of a “search function) enables the encoder to try many different encoding options (partitioning, prediction modes, transforms and the like) in order to decide on the most efficient option. Once the best options have been found, the final encoding is performed using these best options to produce an encoded bit-stream that can be decoded by a compliant decoder.

In general, the efficiency of the final encoding (a measure of the quantity of encoded output data for a comparable image quality) will improve with the number of trial encodings which are performed. This is because an increased number of trial encodings will enable the encoding apparatus to explore a wider range of parameter space (e.g. an increased number of options such as block size and shape) which may thus enable the apparatus to identify a more efficient mode of operation for encoding the image data.

However, an increased number of trial encodings increases the computational effort required for encoding the image data. Increased computational effort requires increased computational resources (e.g. demands on hardware). Furthermore, increased computational effort may increase the time required for encoding. This can make it difficult to produce an encoded bit-stream in certain situations which require the bit-stream to be produced in a short period of time. This can include a real-time implementation of an encoding device, for example.

On the other hand, a reduction in the number of trial encodings may decrease the computational effort. However, this may reduce the efficiency of the final encoding which is produced (e.g. may result in a larger quantity of encoded output data for comparable image quality). Therefore, a reduction in the number of trial encodings is often undesirable.

Parallel processing may enable the encoding apparatus to perform a number of the trial encodings simultaneously. This may reduce the amount of time required to perform the trial encodings. However, the nature of the processing performed by an encoding apparatus makes it very difficult to use parallel processing.

Consider, again, the example of FIG. 7 of the present disclosure. In the example of FIG. 7, for each trial encoding a residual image is supplied to a transform unit 340 which generates a discrete cosine transform representation of the regions of the residual image data. Then, the output of the residual image data is passed to the quantizer and the quantized data is supplied to the data scan unit 360. At this stage, the scanned coefficients are then passed to the entropy encoder 370 for encoding.

Various types of entropy encoding may be used by the encoding apparatus. Two examples are variants of the so-called CABAC (Context Adaptive Binary Arithmetic Coding) system and variants of the so-called CAVLC (Context Adaptive Variable-Length Coding) system. In general, codecs use CABAC for much of their entropy coding. In particular, codecs such as the Versatile Video Coding (VVC) codec and the High Efficiency Video Coding (HEVC) codec use CABAC for much of their entropy coding.

As explained, CABAC is a very efficient process, capable of providing a very efficient bit-stream. However, CABAC is a serial process, since coding is performed with respect to a context and the context's statistics are modified every time a bit is encoded. More specifically, context modelling provides estimates of conditional probabilities of the coding symbols. This enables inter-symbol redundancy to be exploited by switching between different contexts.

As an example, coding a data symbol using CABAC first requires Binarization of the data. During this process, the data symbol is converted to a binary code. Then, a context model is selected, the context model providing a probability of each bin of the binarized symbol being either a “1” or a “0”. Arithmetic coding is then performed according to the selected probability model. Once the coding has been performed, the selected context model is updated based on the actual coded value. That is, if the coded value was a “1” then the probability of a bin being a “1” is increased. On the other hand, if the coded value was a “0” then the probability of the bin being a “0” is increased. Thus, the probability of each bin of the binarized symbol being either a “1” or a “0” as defined by a given context is updated based on the actual coded value.

This means that the way in which each bit is encoded changes depending on the bits which have previously been encoded. Accordingly, it is very difficult to perform this processing in parallel.

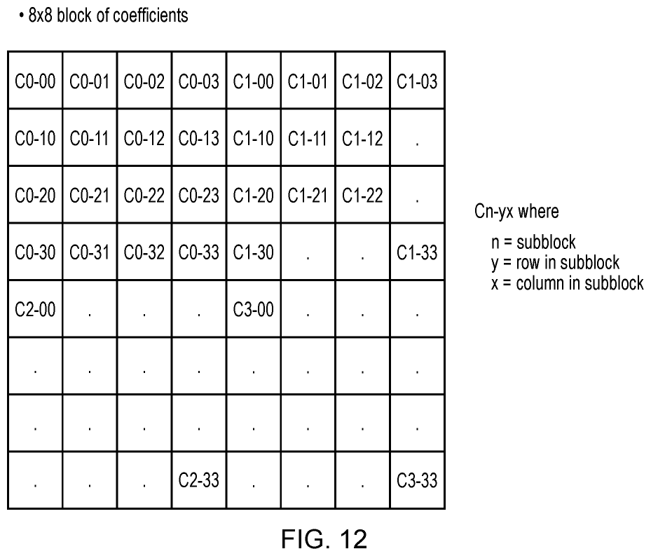

Consider, now, FIG. 12 of the present disclosure. FIG. 12 schematically illustrates a block of image data in accordance with embodiments of the disclosure.

The block of image data illustrated in FIG. 12 of the present disclosure may be image data passed from the data scan unit 360 to the encoder 370 for encoding. In particular, the image data illustrated in FIG. 12 of the present disclosure is a 8×8 block of coefficients, described by the notation Cn-yx, where n is a sub-block, y is a row in sub-block and x is a column in sub-block. Accordingly, in this example, the coefficient at the top left-hand corner has is sub-block CO-00 and the coefficient at the bottom right-hand corner is sub-block C3-33.

During the encoding process, the coefficients of the block of image data illustrated in FIG. 12 of the present disclosure must be processed in series.

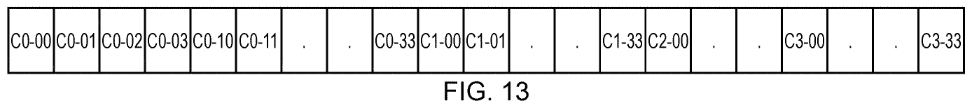

FIG. 13 of the present disclosure schematically illustrates a block of image data in accordance with embodiments of the disclosure. The block of image data shown in FIG. 13 of the present disclosure corresponds to the block of image data illustrated in FIG. 12 of the present disclosure. However, the block of image data shown in FIG. 13 of the present disclosure has been re-arranged in order to represent how the individual coefficients are processed during the encoding process. An entropy encoder such as entropy encoder 370 performing CABAC encoding must sequentially process each coefficient of the image data (e.g. using a single processor core). This is because the result of encoding one coefficient (such as coefficient C04) will depend on the result of the previously encoded coefficients (e.g. C00, C01, C02 and C03), as the context model (providing an estimate of conditional probabilities of the coding symbols) is updated depending on the value of the symbol being encoded.

Accordingly, entropy encoding such as CABAC performed by the entropy encoder 370 cannot be sped up by parallel processing (as it is not possible to perform this CABAC processing in parallel).

Furthermore, as the encoding apparatus (such as that illustrated in FIG. 7) comprises a number of different units, the encoding process cannot be sped up by parallel processing, where other parts of the encoding process depend on the results of CABAC (even if those individual parts of the encoding process could (in themselves) be performed in parallel). As an example, a number of trial encodings of a first block may be performed in parallel when those trial encodings are not dependent on each other (e.g. a number of trial encodings using different options for transform or quantization). However, encoding of a second, subsequent, block might then require the encoder to start with probabilities chosen during encoding of the first block. Thus, trial encodings (such as those used by the encoder as part of a “search function”) cannot be sped up by parallel processing, when they depend on the result of the entropy encoding (such as CABAC).

Accordingly, there is a problem in that it can be difficult to provide an encoding system that can produce an efficient bit-stream, capable of being decoded by a corresponding decoding system, in a short period of time.

It is an aim of the present disclosure to address this issue.

### Encoding Process

With CABAC it may be possible to perform trial encodings in parallel if they use independent context models. However, when an encoding depends on the result of a previous encoding (e.g. coefficients in a block which use a same context (such as the block of image data described with reference to FIGS. 12 and 13 of the present disclosure)), the speed of the encoding process cannot be increased by parallel processing. Accordingly, parallel CABAC encodings cannot be used in order to perform trial encodings of the image data.

This makes it very difficult to provide an encoding system capable of producing an efficient bit-stream in a short period of time.

However, the inventors have realised that the speed of the encoding process may be increased by providing an alternative method of encoding the image data which can be used in parallel. This enables the encoder to perform encoding (such as trial encoding) in parallel in order to quickly and efficiently determine the best encoding options to produce an encoded bit-stream that can be decoded by a compliant decoder. In particular, the inventors have realised that by using a context model with a predetermined configuration for a block of image data, the image data can be encoded in parallel (thus speeding up the encoding process). Moreover, by updating the predetermined context model at certain locations during the encoding process (e.g. at the start/end of each parallel coding) a reliable and accurate estimate of the statistics a CABAC encoding would use can be obtained (i.e. an estimate similar to the results which would be obtained had CABAC been run to generate those statistics).

The closer the estimate is to the final encoding method used (e.g. a full CABAC encoding) the better the coding efficiency will be. This is because better (i.e. more accurate) decisions will be made by the encoder.

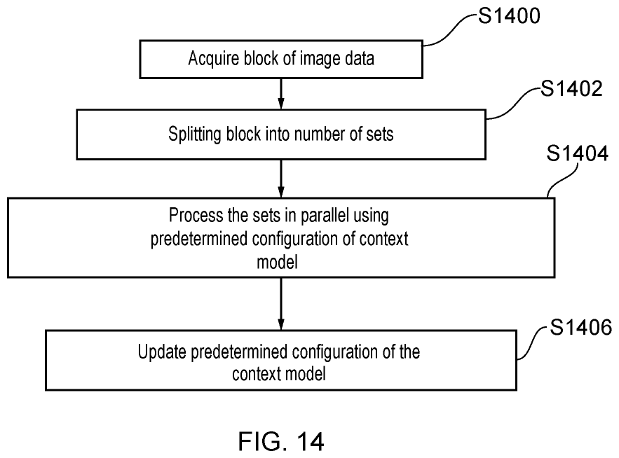

As such, a data encoding method is provided in accordance with embodiments of the disclosure. FIG. 14 illustrates an encoding method in accordance with embodiments of the disclosure.

The data encoding method illustrated in FIG. 14 comprises acquiring a block of image data to be encoded, the block being formed of a number of data items. This is illustrated in step 1400 of FIG. 14. The method further comprises splitting the block of image data into a number of sets, each set having a predetermined length in data items. This is illustrated in step 1402 of FIG. 14. Then, for each set, the method comprises processing the sets in parallel using a predetermined configuration of a context model. This is illustrated in step 1404 of FIG. 14. Finally, the method comprises updating the predetermined configuration of the context model. This is illustrated in step 1406 of FIG. 14.

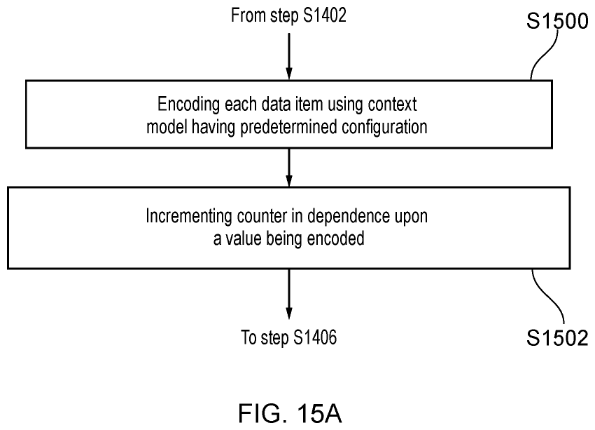

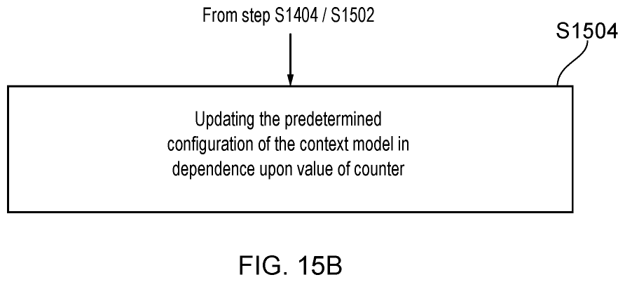

FIG. 15A illustrates a data encoding method in accordance with embodiments of the disclosure. Specifically, FIG. 15A illustrates a number of sub-steps of step S1404 of FIG. 14 of the present disclosure.

In the example of FIG. 15A, the process flows from step S1402 of FIG. 14. The steps S1500 and S1502 of FIG. 15 are then performed in parallel for each set, using a predetermined configuration of the context model. That is, in step S1500, the method comprises encoding each data item (of the set) using a context model having a predetermined configuration. Then, in step S1502, the method comprises incrementing a counter in dependence upon a value being encoded. The method then proceeds to step S1406 (as described with reference to FIG. 14 of the present disclosure).

FIG. 15B illustrates a data encoding method in accordance with embodiments of the disclosure. Specifically, FIG. 15B illustrates, in more detail, the step S1406 of FIG. 14 of the present disclosure.

In the example of FIG. 15B, the process flows from step S1404 of FIG. 14 or step S1502 of FIG. 15A of the present disclosure.

Then, in step S1504, the method comprises updating the predetermined configuration of the context model in dependence upon the value of the counter.

Thus, in the method described with reference to FIG. 14 and FIGS. 15A and 15B of the present disclosure, a predetermined configuration of the context model is used to encode each set of the block of image data in parallel. Then, the configuration of the context model (e.g. the relative probabilities of the context model) are updated periodically (i.e. once the data sets of the block have been encoded).

This enables the encoding process to be performed in parallel for a block of image data, as the configuration of the context model is updated only periodically during the encoding process. That is, in contrast to a CABAC encoding, the result of encoding one coefficient will not depend on the result of the previously encoded coefficients as the same (i.e. fixed) predetermined configuration of the context model is used during the encoding process. However, because the predetermined configuration of the context model is updated at certain stages during the encoding process, the context model can be “synchronised” across parallel processing streams, which thus enables a reliable and accurate estimate of the statistics a CABAC encoding would use can be obtained (i.e. an estimate similar to the results which would be obtained had CABAC been run to generate those statistics).

A data encoding apparatus configured to perform this data encoding method and a computer program which, when implemented by a computer, causes the computer to perform this data encoding method are also provided in accordance with embodiments of the disclosure.

Furthermore, in some examples a video data capture, transmission, display and/or storage apparatus comprising the data encoding apparatus may be provided.

While embodiments of the disclosure are described with reference to data encoding, the present disclosure is not particularly limited in this regard. That is, a data decoding method, data decoding apparatus and a data decoding computer program capable of decoding data encoded by the encoding process of the present disclosure may also be provided.

Further details of embodiments of the disclosure will now be described.

### Parallel Processing Streams

As explained with reference to FIG. 14 of the present disclosure, the encoding method of embodiments of the present disclosure comprises the steps of acquiring the block of image data to be encoded and splitting the block of image data into a number of sets.

The step of acquiring the block of image data (step S1400 of the method illustrated with reference to FIG. 14 of the present disclosure), will depend, at least in part, on the specific context in which the embodiment of the disclosure is being applied.

For example, embodiments of the disclosure may be applied to an example image data compression and decompression apparatus such as that illustrated with reference to FIG. 7 of the present disclosure. In such an example, the encoding method of the present disclosure may be performed by an entropy encoder such as entropy encoder 370 described with reference to FIG. 7 of the present disclosure. In this example, the block of image data acquired during step S1400 of the method of FIG. 14 may be scanned coefficients output by the scan unit 360.

However, the present disclosure is not particularly limited in this regard. More generally, the block of image data acquired in step S1400 may correspond to any portion of image data to be encoded by the encoder.

For example, in some situations the image data may be subject to a transform (such as a DCT) prior to being acquired in step S1400. On the other hand, in some examples (such as during a transform-skip mode of operation) the image data may not have been subject to a transform at all.

Thus, more generally, the block of image data which is acquired may correspond to any portion of image data to be encoded by the encoder.

Consider, again, the example of FIG. 12 of the present disclosure. In the example of FIG. 12 of the present disclosure, a block of image data is illustrated. The block of image data is an 8×8 block of data items to be encoded. Furthermore, in this example, the data items to be encoded are scanned-coefficients. More generally, a block of image data of any size may be acquired. For example, the block of image data may comprise a block of 128×128 coefficients. Alternatively, a block of image data smaller that the 8×8 block of coefficients illustrated in FIG. 12 may also be acquired in accordance with embodiments of the disclosure.

Once the block of image data to be encoded has been acquired, the method comprises splitting the block of image data into a number of sets, each set having a predetermined length in data items.

The image block is split into a number of sets in order that the different sets of the image data can be processed in parallel. That is, in contrast to the example of FIG. 13 of the present disclosure (which corresponds to processing the block of image data in series), according to embodiments of the disclosure, the block of image data is split into a number of sets with each set being processed in parallel by the encoder.

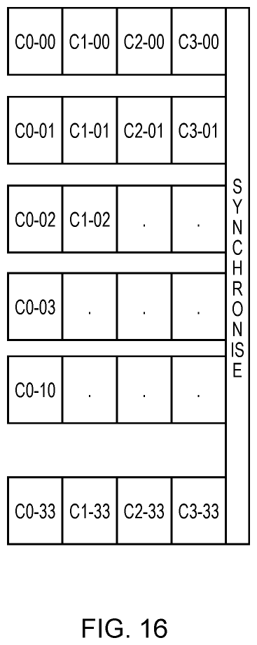

Consider, now, the example of FIG. 16 of the present disclosure. FIG. 16 illustrates a block of image data in accordance with embodiments of the disclosure.

In this example, a block of image data is shown which corresponds to the block of image data shown described with reference to FIG. 12 of the present disclosure. However, in this example, the block of image data has been split into a number of sets, each set having a length of four data items (or coefficients). That is, in this example, the block of image data has been split into 16 sets, each set having a length of four data items (or coefficients). Only five of these 16 sets are illustrated in the example of FIG. 16 of the present disclosure.

Each set of the image data can then be processed in parallel by the entropy encoder. That is, within a set, the coefficients are encoded in series by the entropy encoder. However, the different sets of the image data are themselves processed in parallel by the entropy encoder.

For example, different sets of the image data may be processed by different processor cores. In the case of 16 different sets (as described in the example of FIG. 16 of the present disclosure) the encoding can then be performed by 16 different processing cores.

Thus, in some examples, the encoding method of the present disclosure may be implemented using a processing unit having a number of discrete cores, with each of the cores being used to perform encoding of the block of image data in parallel. In some examples, the processing unit having a number of discrete cores may be a graphical processing unit (GPU). In other examples, the processing unit having a number of discrete cores may be a central processing unit (CPU). The present disclosure is not particularly limited in this regard.

By splitting the image data into a number of different sets (or processing streams) entropy encoding of the image data can be performed in parallel for each of the different sets. This improves the speed and efficiency with which the image data can be encoded.

While the example of FIG. 12 illustrates an example of 16 different sets (each with four coefficients), it will be appreciated that the present disclosure is not particularly limited in this regard. The number of sets may depend upon the size of the image block, the number of processing cores available, or the like. Therefore, the number of sets (and the length of each set) is not particularly limited to the example shown in FIG. 12 of the present disclosure. More generally, any number of sets (of any length) can be generated in accordance with embodiments of the disclosure depending on the situation to which the embodiments of the disclosure are applied. Furthermore, the length of the set can be used in order to control the time at which update processing is performed. This will be described in more detail later.

### Counter

Once the block of image data has been split into sets, each of those sets of image data can be encoded, in parallel, to generate the encoded data. In examples, the encoded data generated in accordance with embodiments of the disclosure is an estimate of the encoding results which would be obtained had a CABAC encoding been run on the image data (in series).

Consider again the example of FIG. 16 of the present disclosure. FIG. 16 of the present disclosure illustrates a block of image data, where the block of image data has been split into a number of sets. Each of these sets can be processed in parallel by the entropy encoder.

As previously explained, when a full CABAC encoding is performed on the image data, the image data must be encoded in series. That is, CABAC is a serial process, since coding is performed with respect to a context and the context's statistics are modified every time a bit is encoded.

In contrast, the encoding method of the present disclosure is not a serial process. That is, in the encoding method of the present disclosure, the context's statistics are not modified every time a bit is encoded. Instead, a predetermined configuration of the context is used in order to encode the bits of the image data, with that configuration of the context being updated only at specific stages through the encoding process. As the context's statistics are not modified every time a bit is encoded, the result of encoding one bit does not depend on the result of encoding any other bit (before the update of the configuration of the context is performed). This enables the image data to be encoded in parallel.

Consider the example of FIG. 16 of the present disclosure. In this example, the image data to be encoded has been split into 16 sets, with each set comprising 4 data items (e.g. coefficients). 16 processing cores are available and therefore each of the 16 sets can be processed in parallel.

During the encoding process, a predetermined configuration of the context model is applied. That is, the entropy encoder may perform arithmetic coding of the image data, using a predetermined configuration of the context model. As previously explained, the context model provides a statistical probability of each bit being either a “1” or a “0” (where the image data has been subject to Binarization processing). That is, the Binarization processing converts each data item to be encoded into a series of bits, with each bit being either a “1” or a “0”. The predetermined configuration of the context model defines the statistics of the context model (i.e. the likelihood of each bit being either a “1” or a “0”). This same predetermined configuration is applied for all bits within the sets being encoded. The predetermined configuration is only updated at certain stages during this encoding process. This will be described in more detail later.

While the encoding process is performed without updating the predetermined configuration when each bit is encoded, the encoding method of the present disclosure still comprises tracking the value of the bits which have been encoded (through use of a counter) in order that the predetermined configuration of the context model can be updated at the relevant stage of the encoding process. This ensures that a result similar to a serial encoding process (such as CABAC) can be obtained.

Specifically, in embodiments of the disclosure, for each set, in parallel: the method comprises encoding each bit of the set using a context model, the context model having a predetermined configuration; and incrementing a counter in dependence upon a value being encoded, wherein the counter is shared across the number of sets.

The counter may be incremented when the value of the bit being encoded is a “0”. Thus, the counter may track the number of the bits which have been encoded which had the value “0”. The use of a single counter to track the number of bits which had the value “0” may be used when the total number of bits to be encoded is known.

In some examples, the encoder may use two counters. Together, these two counters may track the total number of bits which have been encoded and the relative number of those bits which had the value of “0” compared to the number of bits which had the value “1” (where the image data is subject to Binarization processing).

As a specific example, two counters CountT and Count1 may be provided. These counters may be incremented according to the bit value being encoded:
Bit==0: CountT is incremented
Bit==1: CountT and Count1 are both incremented

Thus, CountT keeps a tally of how many bits have been encoded, since CountT is incremented when the value of the bit is “0” and when the value of the bit is “1”. On the other hand, Count1 keeps a tally of how many of those bits were “1” (since Count1 is only incremented when the value of the bit is “1”).

In this specific example, the number of bits which had the value “0” may be calculated by subtracting the value of Count1 from the value of CountT.

Thus, whenever a bit is encoded, the value of a counter (either CountT or CountT and Count1 in this specific example) is incremented. This enables a tally of the number of bits which had a value of “0” and the number of bits which had a value of “1” to be maintained, even though these values do not directly affect the configuration of the context model at the time at which the bit is encoded by the entropy encoder.

It will be appreciated that the present disclosure is not particularly limited to the specific use of CountT and Count1 as described in this example. That is, any suitable counter (or number of counters) may be used in order to track the value of the bits which have been encoded during the parallel processing stage.

For example, in some situations a first count (Count0) may incremented when a “0” is encoded and a second, different, counter (Count1) may be incremented when the value is a “1”. Thus, the number of “0's” which had been encoded and the number of “1's” which had been encoded during the encoding process can be tracked through the use of two separate counters. In this example, the total number of bits which have been encoded could then be determined by adding together the values of both Count0 and Count1.

In some examples, the encoding of the present disclosure may be applied in parallel for each context model. That is, there may be a number of different context models, each context model providing a different statistical probability (or predetermined configuration) of each bit being either a “1” or a “0” (where the image data has been subject to Binarization processing). During a trial encoding stage of the encoding process, the encoder may encode the image data using a number of different context models such that these different encodings can be compared and used to select the final encoding which should be used by the encoder. Alternatively, different blocks of image data may be encoded in parallel provided that each block of image data is encoded with a different context model. That is, with CABAC, it is possible to perform trial encodings in parallel if they use independent contexts (as the encoding performed with a first context will not affect encoding performed with a second, independent, context).

In this situation, when different encoding is performed in parallel for different context models, a separate counter (or set of counters) may be used for each context model.

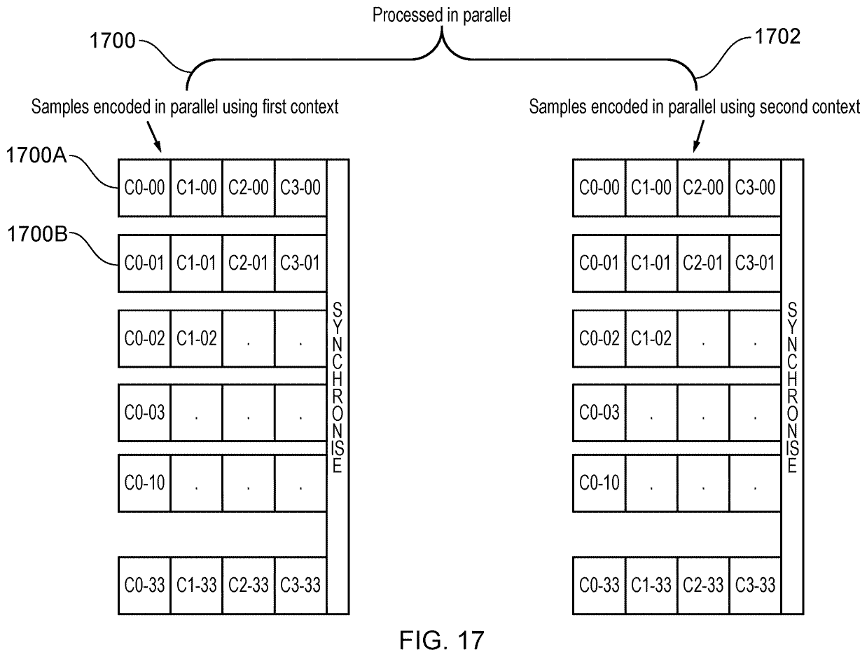

Consider the example of FIG. 17 of the present disclosure. FIG. 17 of the present disclosure illustrates an example processing flow in accordance with embodiments of the disclosure.

In this example, the block of image data described with reference to FIG. 12 of the present disclosure has been split into 16 sets, each set having a predetermined length of 4 data items. A trial encoding is performed in order to test the encoding of the block of image data using both a first context model (having a first predetermined configuration) and a second, independent context model (having a second predetermined configuration). As the first and second context model are independent, they can be processed in parallel by the encoder. The processing of the image block with the first context model occurs in processing stream 1700 and the processing of the image block with the second context model occurs in the processing stream 1702.

Furthermore, within each processing stream, the different sets of the block of image data can be processed in parallel. For example, within the first stream 1700, the first set 1700A may be encoded in parallel to the second set 1700B. Notably, parallel processing within processing stream 1700 or 1702 (i.e. parallel processing using the same context) is possible because the same predetermined configuration of the relevant context model is used (i.e. without performing an update of the context model at the time when each bit of the image data is encoded).

Accordingly, when different contexts are encoded in parallel, a different counter (or set of counters) is used for each context such that at a certain time during the encoding process, each context can be updated using the value of the respective counter pertaining to that context.

### Updating the Context Model

As explained, different sets of the image data can be encoded in parallel. This improves the speed and efficiency with which the encoding processing can be performed (compared to the case in which the processing is performed in series by the entropy encoder).

However, in order to ensure that the encoded data is efficiently encoded by the encoding apparatus, the predetermined configuration of the context model should be updated periodically throughout the encoding process. This ensures that the encoding method of the present disclosure can provide a similar result to that which would have been obtained had CABAC been used to encode the image data (i.e. with the configuration of the context model being updated when each bit of the image data is encoded).

Indeed, the results can be made more similar to a serial encoding process (e.g. a full CABAC encoding) if the context is updated at the start/end of each parallel encoding.

Thus, in embodiments of the disclosure, the method comprises updating the predetermined configuration of the context model in dependence upon the value of the counter.

In certain examples, updating the predetermined configuration of the context model comprises synchronizing the context model across the different parallel processing threads. Consider, again, the example of FIG. 16 of the present disclosure. In this example, the image data to be encoded (a block of image coefficients) has been split into a number of different sets. These sets have been encoded using a context model with a predetermined configuration of the context model (i.e. a configuration which remains fixed across the parallel processing threads). Then, at a predetermined time (e.g. when the data items of the individual sets have been encoded) the context model can be synchronised in dependence upon the value of the counter—with that counter reflecting the number of bits which have been encoded which had a value “0” and the number of bits which have been encoded which had a value of “1” across the individual sets which have been encoded. Thus, the updated model reflects the “context” of the bits which have been encoded (i.e. the value of those bits) in order to bring the context model into a similar configuration as if the context model had been updated after each bit of the image block had been encoded. Thus, in the example of FIG. 16, the context model is updated (or “synchronized”) once the data items of the respective sets of the block of image data have been encoded.

In an example such as FIG. 17 of the present disclosure (where different context models are also processed in parallel) the respective context models may be updated independently from each other. That is, the configuration of each context model can be updated (i.e. synchronized) for each context model at a different time depending on factors such as when the parallel processing of the sets has been completed for each respective context model.

As explained, the process of updating the context model is performed for each parallel process of the context in order to bring the context model in a similar state as if the encoding had been performed in series (i.e. with an update occurring at the time at which each bit of the image data was encoded). In particular, this changes the statistics of the context model (i.e. the likelihood of a bit being either a “0” or a “1”). Furthermore, in some examples, it will be appreciated that this update processing is performed in dependence upon the value of the counter which has been incremented during the parallel processing. This provides an efficient way of encoding the image data in parallel while maintaining a required degree of similarity with the results of CABAC processing of the image data in series.

However, there are a number of different ways by which the predetermined configuration of the context model can be updated (including a number of different ways of using the value of the counter (or counters)). Accordingly, it will be appreciated that the present disclosure is not particularly limited in this regard.

In some examples, the predetermined configuration of the context model may be updated in accordance with a calculation performed using the value of the counter.

Furthermore, in some examples, the calculation can comprise a comparison of the value of the counter with one or more threshold values.

Indeed, in some examples, the predetermined configuration of the context may be updated in accordance with the equation:

$$Mvalue = ( A * Value 0 + B * Mvalue / C )$$

wherein Mvalue is a value corresponding to the current configuration of the context model, A is a constant, B is a constant, C is a constant and Value0 is a value calculated by comparison of the value of the counter with a threshold value. In this example, Value0 may be calculated by comparison of the value of the counter with a threshold value in accordance with the conditions:

$$\begin{matrix}if CountT > Size 0 & Value 0 = D ⋆ Count 1 / CountT \\ else & Value 0 = ( D ⋆ Count 1 + Mvalue ⋆ ( Size 0 - CountT ) ) / Size 0\end{matrix}$$

wherein, CountT is a first counter which is incremented when the value is “0” or “1”, Count1 is a second counter which is incremented when the value is “1”, and Size0 is a predetermined threshold value.

In some specific examples, the value of the constant A may be 11, the value of constant B may be 5, the value of constant C may be 16 and the value of constant D may be 256.

However, the present disclosure is not particularly limited to these specific values of the constants.

Furthermore, the value of the threshold Size0 may be determined in accordance with the equation:

$$Size 0 = {2}^{⋀} ( DWS / 16 )$$

wherein DWS is the default window size. Thus, in an example where the default window size is 8, the value of Size0=1.

Thus, in certain examples of the present disclosure, these equations can be used in order to update the predetermined configuration of the context model in accordance with the value of the bits which have been encoded during the parallel processing (i.e. the number of either “0s” or “1s” which have been encoded).

These equations provide an example where a comparison is made against a single threshold, Size0. However, the present disclosure is not particularly limited in this regard. In some examples, a calculation can be performed in order to update the predetermined configuration of the context model in using equations to compare the value of the counter against more than one threshold value. In examples, a comparison can be made against two threshold values. However, in other examples, a comparison with more than two threshold values may be made. Comparison with a plurality of threshold values enables different “windows” to be provided. For example, a first value (such as Value0) may be used in order to update the configuration of the context on a “short term” basis—i.e. based on small changes in the numbers of “0s” or “1s” which are encoded. On the other hand, a second value may be used in order to reflect “longer term” patterns in the numbers of “0s” or “1s” which have been encoded. Thus, the use of a plurality of thresholds may therefore further improve the accuracy and efficiency with which the predetermined configuration of the context model can be updated.

Indeed, in some examples, the predetermined configuration of the context may be updated in accordance with the equation:

$$MValue = ( A * ( Value 0 + Value 1 ) / 2 + B * Mvalue ) / C$$

wherein Mvalue is a value corresponding to the configuration of the context model, A is a constant, B is a constant, C is a constant, Value0 is a value calculated by comparison of the value of the counter with a first threshold value and Value1 is a value calculated by comparison of the value of the counter with a second threshold value. In this specific example, Value0 may be calculated by comparison of the value of the counter with a threshold value in accordance with the conditions:

$$\begin{matrix}if CountT > Size 0 & Value 0 = D * Count 1 / CountT \\ else & \begin{matrix}Value 0 = ( D * Count 1 + Mvalue * \\ ( Size 0 - CountT ) ) / Size 0\end{matrix}\end{matrix}$$

and Value1 is calculated by comparison of the value of the counter with a threshold value in accordance with the conditions:

$$\begin{matrix}if CountT > Size T & Value 1 = D * Count 1 / CountT \\ else & \begin{matrix}Value 1 = ( D * Count 1 + Mvalue * \\ ( SizeT - CountT ) ) / SizeT\end{matrix}\end{matrix}$$

wherein, CountT is a first counter which is incremented when the value is 0 or “1”, Count1 is a second counter which is incremented when the value is “1”, and Size0 is a first predetermined threshold value and SizeT is a second predetermined threshold value.

In some specific examples, the value of the constant A may be 11, the value of the constant B may be 5, the value of the constant C may be 16 and the value of the constant D may be 256.

However, the present disclosure is not particularly limited to these specific values of the constants.

Furthermore, in this example, the value of the threshold Size0 may be determined in accordance with the equation:

$$Size 0 = {2}^{⋀} ( DWS / 16 )$$

and the value of the threshold Size1 may be determined in accordance with the equation:

$$Size 1 = {2}^{⋀} ( DWS \& 15 ) ,$$

wherein DWS is a default window size.

Thus, in certain examples of the present disclosure, these equations can be used in order to update the predetermined configuration of the context model in accordance with the value of the bits which have been encoded during the parallel processing (i.e. the number of either “0s” or “1s” which have been encoded).

Furthermore, the present disclosure is not particularly limited to the use of two separate threshold values for the update of the predetermined configuration of the context model. In some examples, more than two threshold values may be used. As explained, comparison with a plurality of threshold may further improve the accuracy and efficiency with which the predetermined configuration of the context model can be updated, since each threshold can be set to reflect a certain sensitivity to patterns in the numbers of “0s” or “1s” which have been encoded.

While a number of examples of updating the predetermined configuration of the context model using calculations in dependence upon the value of the counter have been provided, it will be appreciated that the present disclosure is not particularly limited in this regard. More generally, any suitable method of updating the predetermined configuration of the context model in dependence upon the value of the counter can be performed in accordance with embodiments of the disclosure.

In some examples, the predetermined configuration of the context model may be updated using a lookup table using the value of the counter which has been incremented during the parallel encoding of the block of image data. The use of a lookup table to update the predetermined configuration of the context model may further improve the speed with which the predetermined configuration of the context model can be updated.

Thus, in some examples, Mvalue (the value corresponding to the current configuration of the context model) can be derived or updated from a 1D lookup table:

$$Mvalue = LUT ( fn ( CountT , Count 1 ) )$$

wherein CountT is a first counter incremented when the value of the encoded bit is a “0” or a “1” and Count1 is a second counter incremented when the value of the encoded bit is a “1”.

Alternatively, in some examples, Mvalue may be derived or updated from a 2D lookup table:

$$Mvalue = LUT ( fn ( CountT , fn ( Count 1 ) )$$

wherein CountT is a first counter incremented when the value of the encoded bit is a “0” or a “1”, Count1 is a second counter incremented when the value of the encoded bit is a “1” and the fn is a function performed on the value of CountT and the value of Count1. In examples, the fn may be a log function. The use of a log function enables non-linear mapping between the values of the counters and the configuration of the context model to be provided.

Hence, more generally, any suitable method of updating the predetermined configuration of the context model (or context models) in dependence upon the value of the counter can be provided in accordance with embodiments of the disclosure.

The purpose of updating the predetermined configuration of the context model once the parallel processing has been performed is to bring the configuration of the context model into a similar state to that which it would have been in had the configuration of the context model been updated after each value had been encoded (as occurs during serial processing, such as CABAC). This improves the accuracy and reliability of the parallel processing encoding. Once the context model has been updated, the updated context model is used for a next block of image data to be encoded.

In examples, the parallel processing can be performed for a plurality of different context models. In examples, this may include parallel processing for all available context models (such as all the context models available in CABAC). However, in other examples, the parallel processing may be performed for a sub-set of all available context models. The number of context models for which the parallel processing is performed may depend on factors such as the available computational resources (such as the number of available processor cores or the like).

Now, while the process of updating the predetermined configuration of the context model has been described, it will be appreciated that the time at which the context model is updated may vary depending upon the situation to which the embodiments of the disclosure are applied. That is, in some examples, the process of updating the predetermined configuration of the context model may be performed more frequently (e.g. after a small number of data items have been encoded). On the other hand, in other examples, the process of updating the predetermined configuration of the context model may be performed less frequently (e.g. after an increased number of data items have been encoded). In general, the update processing should be performed as frequently as required in order to ensure that the parallel encoding remains similar to the encoding as would be attained during serial encoding of the image data (i.e, wherein the predetermined configuration of the context model is updated after each bit was encoded).

Consider, now, the example described with reference to FIG. 16 of the present disclosure. In this example, a block of image data has been split into a number of sets, with each set having a length of four data items (i.e. four coefficients from the block of image data).

In this example, the update processing (“synchronization”) is performed once the four data items from each set have been encoded. Thus, the update processing in this example is performed quite frequently (after four data items have been encoded). The point at which the update processing is performed is the synchronization point. Thus, the update processing is run for each parallel process of the context model, leaving the context model in a similar state as if the encoding had been done in a serial manner (e.g. using CABAC in series).

In the case where a number of context models are processed in parallel (such as that the example situation described with reference to FIG. 17 of the present disclosure) the synchronization point may be different for the different context models. That is, in FIG. 17, the length of each set for the first context is four data items and the length of the sets in the second context is also four data items. This means that the synchronization point for the first context model and the second context model is the same in this example (i.e. it occurs once the four data items (coefficients) of each set have been processed). However, in other examples the synchronization point for the first context may be different than the synchronization point for the second context. As a specific example, the block of image data may, for the first context model, be split into a number of sets having a predetermined length of four data items. Thus, the synchronization processing for the first context model would occur once each parallel process of the context model had been completed. On the other hand, the block of image data may, for the second context model, be split into a number of sets having a predetermined length of eight data items. Thus, the synchronization processing for the second context model would occur at a different time to the first context model (i.e. only after the eight data items had been encoded for each parallel process of the context model).

Therefore, it will be appreciated that the synchronization point may be different for different context models.

Furthermore, in some examples, the synchronization point (i.e. the point at which the update processing is performed) may vary depending on factors such as the stability of the context model (i.e. how much the context model changes after the update processing has been performed) the amount of image data which has been encoded or the like. As a specific example, the length of each set in data items (defining the synchronization point) may be quite short for a first batch of parallel processing (e.g. a first block of image data). Then, after the context model has been updated, the length of the each set in data items for subsequent batches of processing may be increased if the predetermined configuration of the context model remains relatively stable (i.e. only small changes in the configuration of the context model when the update processing is performed).

By increasing the length of each set in data items (and thus increasing the time before the update processing is performed) the efficiency of the parallel processing can be further improved. Moreover, by tailoring the length of each set in data items, the accuracy and reliability of the parallel processing can be further improved, as it can be ensured that the result of the parallel processing remains similar to serial processing of the image data.

In some examples, the synchronization point can be defined depending on an aspect or feature of the image to be encoded. For example, the length of each set in data items (and thus the synchronization point) can be defined in dependence with the size of a transform unit, a coding unit, a prediction unit, a slice or a picture within the image data to be encoded.

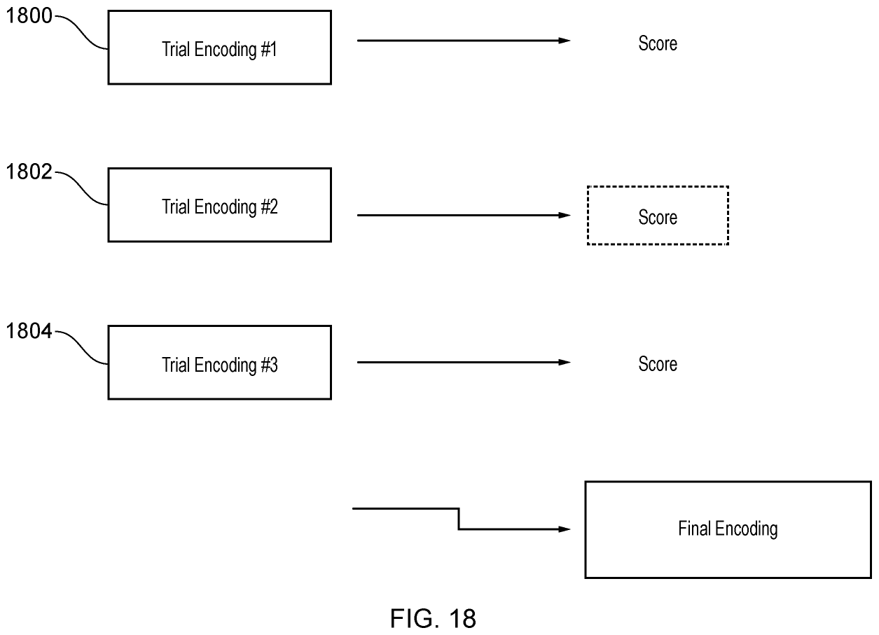

Consider, now, FIG. 18 illustrates an encoding method in accordance with embodiments of the disclosure.

In this example, a number of trial encodings 1800, 1802 and 1804 are shown. Each of these trial encodings represents a trial encoding as may be performed by an apparatus such as the compression/decompression apparatus described with reference to FIG. 7 of the present disclosure. That is, each trial encoding enables the encoder to try many different encoding options (partitioning, prediction modes, transforms and the like) in order to decide on the most efficient option. Once the best options have been found, the final encoding is performed using these best options to produce an encoded bit-stream that can be decoded by a compliant decoder.

According to embodiments of the disclosure, trial encodings can be performed in parallel if these use independent contexts. Furthermore, in accordance with embodiments of the disclosure, trial encodings can also be performed in parallel where they use the same context and where (under a serial processing such as CABAC) one encoding depends on a previous encoding (e.g. coefficients in a block which use the same context). Thus, embodiments of the present disclosure provide a method of encoding which can accurately estimate the results which would have been obtained had a serial processing (such as CABAC) been performed to encode the data.

Thus, in some examples, once the trial encodings have been performed, the cost of each potential selection (trial encoding) in terms of one or both of the number of bits required for encoding and distortion to the picture can be calculated (the “score” of FIG. 18 of the present disclosure). The encoding system may then make a choice concerning a final encoding of the image data according to the cost of each potential selection in terms of one or both of the number of bits required for encoding and distortion to the picture. The final encoding may then, optionally, be performed using a serial processing such as CABAC to produce the final encoded bit-stream (e.g. for a decoder configured to use the serial CABAC decoding).

As such, according to embodiments of the disclosure, a data encoding method is provided, wherein parallel encoding method is performed during a search phase for each of a plurality of trial encodings of image data to be encoded. Furthermore, according to embodiments of the disclosure, this data encoding method may further comprise evaluating each encoding of plurality of trial encodings of the image data; and encoding the image data to be encoded using a Context Adaptive Binary Arithmetic Coding, CABAC, engine in dependence upon the evaluation of the plurality of trial encodings of the image data.

In this way, an encoding system capable of producing an efficient bit-stream, capable of being decoded by a corresponding decoding system, in a short period of time can be provided.

However, in some examples, the parallel encoding (parallel CABAC) method may be used to produce the final encoded bit-stream (e.g. for a decoder configured to use a parallel CABAC method).

As such, according to embodiments of the disclosure, a data encoding method is provided wherein a parallel encoding method is used to generate an encoded bitstream. The encoded bitstream can then be decoded using a decoder configured to decode the bitstream generated by parallel encoding.

Furthermore, in embodiments of the disclosure, a data decoding method is provided, the data decoding method comprising:
receiving an encoded data signal;
splitting the encoded data signal into a number sets, each set having a predetermined length in data items;
for each set, in parallel:
   decoding each data item of the set using a context model, the context model having a predetermined configuration; and
   incrementing a counter in dependence upon a value being decoded, wherein the counter is shared across the number of sets;
and, when the sets have been decoded, updating the predetermined configuration of the context model in dependence upon the value of the counter.

In this way, the data decoding method can be used to decode an encoded bitstream (e.g. to generate image data which has been encoded by the encoder). In particular, this data decoding method may be used when a parallel data encoding method has been used in order to generate the encoded bitstream. That is, the data decoder of this example uses synchronised context models (being synchronised, or “updated” across the parallel decoding threads or streams) to decode the data rather than using the context model in a state after a serial CABAC decoding process (i.e. a situation where the context model is updated after each data item is decoded (serial decoding)).

Embodiments of the disclosure (such as this data decoding method) may be applied to an example image data compression and decompression apparatus such as that illustrated with reference to FIG. 7 of the present disclosure. In such an example, the decoding method may be performed by an entropy decoder such as entropy decoder 410 described with reference to FIG. 7 of the present disclosure.

Once the predetermined context model has been updated, the updated (synchronised) context model can be used to decode a next portion of the encoded data signal. For example, in some embodiments, the decoding method may further include using the updated predetermined configuration of the context model to decode a next set of data items. In this way, a predetermined context model can be used to decode a first set of data in parallel. This predetermined context model can then be updated once the first set of data has been decoded. The updated predetermined context model can then be used to decode a second set of data.

A corresponding data decoding apparatus and data decoding computer program are also within the scope of the present disclosure.

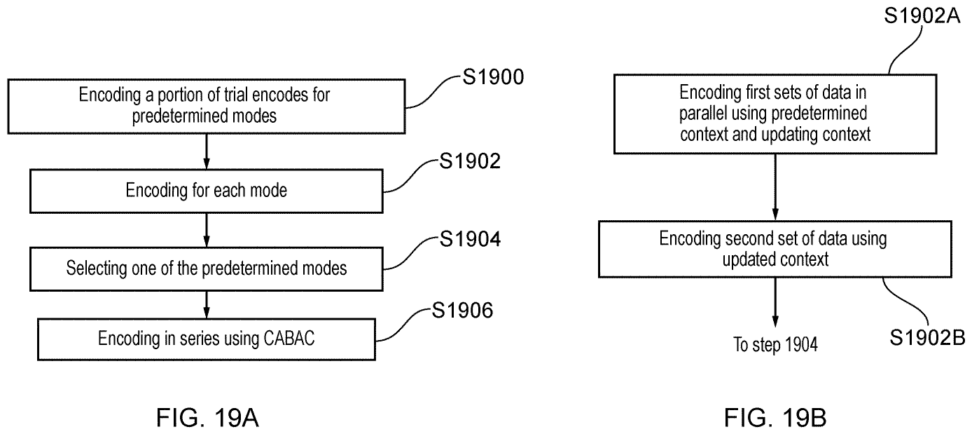

Consider, now, FIGS. 19A and 19B of the present disclosure. FIGS. 19A and 19B illustrate an example data encoding method in accordance with embodiments of the disclosure. Specifically, FIG. 19A illustrates the steps S1900, S1902, S1904 and S1906 of the example data encoding method, while FIG. 19B illustrates a number of sub-steps of the step S1902 of this example method.

The example data encoding method illustrated in FIGS. 19A and 19B of the present disclosure comprises:
encoding (in step S1900) a portion of trial encodes for predetermined modes of encoder operation,
wherein, for each mode (S1902), the method comprises:
   encoding (in step S1902A) first sets (e.g. a first set) of data in parallel using a predetermined context and update the predetermined context when the first set of data has been encoded;
   and encoding (in step S1902B) a second set of data using the updated predetermined context, wherein the first and second set of data correspond to a mode of encoder operation;
and, selecting (in step S1904) one of the predetermined modes of encoder operation; and
encoding (in step 1906) the set of data in series using a Context Adaptive Binary Arithmetic Coding, CABAC engine.

In this example, data encoding for a number of trial encodings is performed (with the trial encodings using a number of different encoding options or modes of encoder operation (such as block size and shape, for example)). For each of these modes of encoder operation, the encoder uses a predetermined (fixed) context to encode first sets of data in parallel (such as a block of image data to be encoded). Then, the predetermined context is updated (e.g. at the “synchronization point”). This brings the predetermined context into a similar state as had the first sets of data been encoded in series. The updated context is then used in order to encode a second set of data.

Once the predetermined modes of encoder operation have been trial encoded in this manner, a predetermined mode of the encoder operation can be selected and used to perform a serial encoding of the data (e.g. using CABAC).

An apparatus and computer program corresponding to this method are also within the scope of the disclosure.

In this way, an encoding system capable of producing an efficient bit-stream, capable of being decoded by a corresponding decoding system, in a short period of time can be provided. A corresponding data decoding method, data decoding apparatus and data decoding computer program are also within the scope of the disclosure.

In addition, embodiments of the present disclosure are defined in accordance with the following numbered clauses:

1) A data encoding method, comprising:
acquiring a block of image data to be encoded, the block being formed of a number of data items;
splitting the block of image data into a number of sets, each set having a predetermined length in data items;
for each set, in parallel:
   encoding each data item of the set using a context model, the context model having a predetermined configuration; and
   incrementing a counter in dependence upon a value being encoded,
   wherein the counter is shared across the number of sets;
and, when the sets have been encoded, updating the predetermined configuration of the context model in dependence upon the value of the counter.
   2) The data encoding method according to clause 1, wherein the predetermined configuration of the context model defines one or more statistics of the context model.
   3) The data encoding method according to clause 1 or 2, wherein the value being encoded is the value of a bit being encoded.
   4) The data encoding method according to any preceding clause, wherein the block of image data is a block of coefficients and wherein each data item is a coefficient.
   5) The data encoding method according to any preceding clause, wherein the counter comprises a first counter which is incremented when the value is 0 and a second counter which is incremented when the value is 0 or 1.
   6) The data encoding method according to any preceding clause, wherein the counter comprises a first counter which is incremented when the value is 0 and a second counter which is incremented when the value is 1.
   7) The data encoding method according to any preceding clause, wherein the data encoding method of any preceding clause is performed in parallel for different context models, each of the different context models having a predetermined configuration of context variables.
   8) The data encoding method according to clause 7, wherein there is a separate counter for each of the different context models.
   9) The data encoding method according to any preceding clause, wherein a calculation is performed based on the value of the counter to update the context model.
   10) The data encoding method according to clause 9, wherein the calculation comprises a comparison of the value of the counter with a threshold value.
   11) The data encoding method according to clause 10, wherein the configuration of the context model is updated in accordance with the equation:

$$Mvalue = ( A * Value 0 + B * Mvalue / C )$$

wherein Mvalue is a value corresponding to the configuration of the context model, A is a constant, B is a constant, C is a constant and Value0 is a value calculated by comparison of the value of the counter with a threshold value.
   12) The data encoding method according to clause 11, wherein Value0 is calculated by comparison of the value of the counter with a threshold value in accordance with the conditions:

$$\begin{matrix}if CountT > Size 0 & Value 0 = D * Count 1 / CountT \\ else & \begin{matrix}Value 0 = ( D * Count 1 + Mvalue * \\ ( Size 0 = CountT ) ) / Size 0\end{matrix}\end{matrix}$$

wherein, CountT is a first counter which is incremented when the value is 0 or 1, Count1 is a second counter which is incremented when the value is 1, and Size0 is a predetermined threshold value.
   13) The data encoding method according to clause 12, wherein Size0=2 (DWS/16), wherein DWS is a default window size.
   14) The data encoding method according to clause 10, wherein the configuration of the context model is updated in accordance with the equation:

$$Mvalue = ( A * ( Value 0 + Value 1 ) / 2 + B * Mvalue ) / C$$

wherein Mvalue is a value corresponding to the configuration of the context model, A is a constant, B is a constant, C is a constant, Value0 is a value calculated by comparison of the value of the counter with a first threshold value and Value1 is a value calculated by comparison of the value of the counter with a second threshold value.
   15) The data encoding method according to clause 14, wherein Value0 is calculated by comparison of the value of the counter with a threshold value in accordance with the conditions:

$$\begin{matrix}if CountT > Size 0 & Value 0 = D * Count 1 / CountT \\ else & \begin{matrix}Value 0 = ( D * Count 1 + Mvalue * \\ ( Size 0 - CountT ) ) / Size 0\end{matrix}\end{matrix}$$

and Value1 is calculated by comparison of the value of the counter with a threshold value in accordance with the conditions:

$$\begin{matrix}if CountT > SizeT & Value 1 = D * Count 1 / CountT \\ else & \begin{matrix}Value 1 = ( D * Count 1 + Mvalue * \\ ( SizeT - CountT ) ) / SizeT\end{matrix}\end{matrix}$$

wherein, CountT is a first counter which is incremented when the value is 0 or 1, Count1 is a second counter which is incremented when the value is 1, and Size0 is a first predetermined threshold value and SizeT is a second predetermined threshold value.
   16) The data encoding method according to clause 15, wherein Size0=2 (DWS/16) and Size1=2\hat{ }(DWS&15), wherein DWS is a default window size.
   17) The data encoding method according to any preceding clause, wherein the context model is updated using a look up table in dependence upon the value of the counter.
   18) The data encoding method according to any preceding clause, wherein the context model is updated using a function in dependence upon the value of the counter.
   19) The data encoding method according to clause 18, wherein the function is a log function.
   20) The data encoding method according to any preceding clause, wherein the updated context model is used for a next block of image data to be encoded.
   21) The data encoding method according to any preceding clause, wherein the predetermined configuration of the context model is determined in dependence upon a previously encoded block of image data.
   22) The data encoding method according to any preceding clause, wherein the block of image data corresponds to a transform unit, a coding unit, a prediction unit, a slice or a picture.
   23) A data encoding method, wherein the method of any preceding clause is performed during a search phase for each of a plurality of trial encodings of image data to be encoded.
   24) The data encoding method according to clause 23, further comprising evaluating each encoding of plurality of trial encodings of the image data; and encoding the image data to be encoded using a Context Adaptive Binary Arithmetic Coding, CABAC, engine in dependence upon the evaluation of the plurality of trial encodings of the image data.
   25) The data encoding method according to any preceding clause, further comprising generating an encoded data signal comprising the encoded block of image data.
   26) A computer program which, when implemented by a computer, causes the computer to perform the data encoding method of any preceding clause.
   27) An encoded data signal generated by the method of clause 24.
   28) An encoded data signal generated by the method of clause 25.
   29) A data encoding apparatus, comprising circuitry configured to:
acquire a block of image data to be encoded, the block being formed of a number of data items;
split the block of image data into a number of sets, each set having a predetermined length in data items;
   for each set, in parallel:
      encode each data item of the set using a context model, the context model having a predetermined configuration; and
      increment a counter in dependence upon a value being encoded,
      wherein the counter is shared across the number of sets;
and, when the sets have been encoded, update the predetermined configuration of the context model in dependence upon the value of the counter.
   30) A video data capture, transmission, display and/or storage apparatus comprising the encoding apparatus of clause 29.
   31) A data decoding method capable of decoding an encoded data signal generated by the method of clause 24.
   32) A computer program which, when implemented by a computer, causes the computer to perform the data decoding method according to clause 31.
   33) A data decoding apparatus comprising circuitry configured to be capable of decoding an encoded data signal according to clause 27.
   34) A video data capture, transmission, display and/or storage apparatus comprising the decoding apparatus according to clause 33.
   35) A data decoding method, comprising:
receiving an encoded data signal;
splitting the encoded data signal into a number sets, each set having a predetermined length in data items;
for each set, in parallel:
   decoding each data item of the set using a context model, the context model having a predetermined configuration; and
   incrementing a counter in dependence upon a value being decoded, wherein the counter is shared across the number of sets;
and, when the sets have been decoded, updating the predetermined configuration of the context model in dependence upon the value of the counter.
   36) A computer program which, when implemented by a computer, causes the computer to perform the data decoding method according to clause 35.
   37) A data decoding apparatus, comprising circuitry configured to:
receive an encoded data signal;
split the encoded data signal into a number sets, each set having a predetermined length in data items;
for each set, in parallel:
   decode each data item of the set using a context model, the context model having a predetermined configuration; and
   increment a counter in dependence upon a value being decoded, wherein the counter is shared across the number of sets;
and, when the sets have been decoded, update the predetermined configuration of the context model in dependence upon the value of the counter.
38) A video data capture, transmission, display and/or storage apparatus comprising the decoding apparatus according to clause 37.

In so far as embodiments of the disclosure have been described as being implemented, at least in part, by software-controlled data processing apparatus, it will be appreciated that a non-transitory machine-readable medium carrying such software, such as an optical disk, a magnetic disk, semiconductor memory or the like, is also considered to represent an embodiment of the present disclosure. Similarly, a data signal comprising coded data generated according to the methods discussed above (whether or not embodied on a non-transitory machine-readable medium) is also considered to represent an embodiment of the present disclosure.

It will be apparent that numerous modifications and variations of the present disclosure are possible in light of the above teachings. It is therefore to be understood that within the scope of the appended clauses, the technology may be practised otherwise than as specifically described herein.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognize that various features of the described embodiments may be combined in any manner suitable to implement the technique.

Furthermore, in the present disclosure, the wording “in dependence upon” defines a relationship by which one value or parameter can be calculated from another value or parameter. That is, “A is calculated in dependence upon B” means that the value of B wholly or in part, directly or indirectly, contributes to a determination or calculation of A. Thus, when A is calculated in dependence upon B, A is at least in part based on a value of B or a value associated with B. Thus, the wording “in dependence upon” and “based on” may be used interchangeable within the present disclosure.

1. A data encoding method, comprising:
acquiring a block of image data to be encoded, the block being formed of a number of data items;
splitting the block of image data into a number of sets, each set having a predetermined length in data items;
for each set, in parallel:
encoding each data item of the set using a context model, the context model having a predetermined configuration; and
incrementing a counter in dependence upon a value being encoded, wherein the counter is shared across the number of sets;
and, when the sets have been encoded, updating, by circuitry, the predetermined configuration of the context model in dependence upon the value of the counter.

2. The data encoding method according to claim 1, wherein the predetermined configuration of the context model defines one or more statistics of the context model.

3. The data encoding method according to claim 1, wherein the value being encoded is the value of a bit being encoded.

4. The data encoding method according to claim 1, wherein the block of image data is a block of coefficients and wherein each data item is a coefficient.

5. The data encoding method according to claim 1, wherein the counter comprises a first counter which is incremented when the value is 0 and a second counter which is incremented when the value is 0 or 1.

6. (canceled)

7. The data encoding method according to claim 1, wherein the data encoding method is performed in parallel for different context models, each of the different context models having a predetermined configuration of context variables.

8. The data encoding method according to claim 7, wherein there is a separate counter for each of the different context models.

9. The data encoding method according to claim 1, wherein a calculation is performed based on the value of the counter to update the context model and comprises a comparison of the value of the counter with a threshold value.

10. (canceled)

11. The data encoding method according to claim 9, wherein the configuration of the context model is updated in accordance with the equation:
$$Mvalue = ( A * Value 0 + B * Mvalue / C )$$
wherein Mvalue is a value corresponding to the configuration of the context model, A is a constant, B is a constant, C is a constant and Value0 is a value calculated by comparison of the value of the counter with a threshold value.

12. The data encoding method according to claim 11, wherein Value0 is calculated by comparison of the value of the counter with a threshold value in accordance with the conditions:
$$\begin{matrix}if CountT > Size 0 & Value 0 = D * Count 1 / CountT \\ else & \begin{matrix}Value 0 = ( D * Count 1 + Mvalue * \\ ( Size 0 - CountT ) ) / Size 0\end{matrix}\end{matrix}$$
wherein, CountT is a first counter which is incremented when the value is 0 or 1, Count1 is a second counter which is incremented when the value is 1, and Size0 is a predetermined threshold value.

13. The data encoding method according to claim 12, wherein Size0=2\hat{ }(DWS/16), wherein DWS is a default window size.

14. (canceled)

15. (canceled)

16. (canceled)

17. The data encoding method according to claim 1, wherein the context model is updated using a look up table in dependence upon the value of the counter or wherein the context model is updated using a function in dependence upon the value of the counter.

18. (canceled)

19. (canceled)

20. The data encoding method according to claim 1, wherein the updated context model is used for a next block of image data to be encoded.

21. (canceled)

22. The data encoding method according to claim 1, wherein the block of image data corresponds to a transform unit, a coding unit, a prediction unit, a slice or a picture.

23. A data encoding method, wherein the method of claim 1 is performed during a search phase for each of a plurality of trial encodings of image data to be encoded.

24. (canceled)

25. (canceled)

26. (canceled)

27. (canceled)

28. (canceled)

29. A data encoding apparatus, comprising circuitry configured to:
acquire a block of image data to be encoded, the block being formed of a number of data items;
split the block of image data into a number of sets, each set having a predetermined length in data items;
for each set, in parallel:
encode each data item of the set using a context model, the context model having a predetermined configuration; and
increment a counter in dependence upon a value being encoded,
wherein the counter is shared across the number of sets;
and, when the sets have been encoded, update the predetermined configuration of the context model in dependence upon the value of the counter.

30. A video data capture, transmission, display and/or storage apparatus comprising the encoding apparatus of claim 29.

31. (canceled)

32. (canceled)

33. (canceled)

34. (canceled)

35. A data decoding method, comprising:
receiving an encoded data signal;
splitting the encoded data signal into a number sets, each set having a predetermined length in data items;
for each set, in parallel:
decoding each data item of the set using a context model, the context model having a predetermined configuration; and
incrementing a counter in dependence upon a value being decoded,
wherein the counter is shared across the number of sets;
and, when the sets have been decoded, updating, by circuitry, the predetermined configuration of the context model in dependence upon the value of the counter.

36. A non transitory storage medium having stored thereon code components that when executed by a computer, causes the computer to perform the data decoding method according to claim 35.

37. (canceled)

38. (canceled)
